(19) United States
(12) Patent Application Publication
(10) Pub. No.: US 2025/0263869 A1
(43) Pub. Date: Aug. 21, 2025

(54) ELECTROSTATIC SEPARATION DEVICE FOR ELASTIC MONO FILAMENTS FROM COTTON STAPLE FIBER YARNS IN FLEECES

(71) Applicant: Säntis Textiles AG, Bühler (CH)

(72) Inventors: Resul ISTREFI, St. Margrethen (CH); Stefan HUTTER, St. Margrethen (CH)

(73) Assignee: Säntis Textiles AG, Bühler (CH)

(21) Appl. No.: 18/862,954

(22) PCT Filed: May 3, 2023
(86) PCT No.: PCT/EP2023/061681

§ 371 Date: Nov. 5, 2024

(30) Foreign Application Priority Data
May 9, 2022 (CH) CH000541/2022

(51) Int. Cl. D01G 21/00; B03C 7/08; D01G 11/00; D01G 15/18; D01G 15/46; D01G 99/00

(52) U.S. Cl. CPC D01G 21/00; B03C 7/08; D01G 11/00; D01G 15/18; D01G 15/46; D01G 99/005; B03C 2201/00; D10B 2331/10

(57) ABSTRACT

The disclosure relates to a device and method for extracting synthetic fiber material from mixed textile waste fiber material containing synthetic fiber material and natural fiber material. An extraction module includes an electrostatic charging unit that is configured to be mountable at a textile recycling machine for electric charging a fiber fleece of mixed textile fiber material and/or for moving charged synthetic fiber material closer to a surface of the fleece, and a separation stage comprising separation means for removing a layer, in particular surface layer, of the fleece containing an increased or decreased concentration of the synthetic fiber material. Also a method for retrofitting a textile recycling machine with such an extraction module is disclosed.

### CROSS-REFERENCE TO RELATED APPLICATIONS

This application is a U.S. National Phase Application that claims the benefit of the filing date of International PCT Application No. PCT/EP2023/061681, filed on May 3, 2023, that claims priority to Swiss Application No. CH000541/2022, filed on May 9, 2022, each of which are hereby incorporated by reference in their entirety.

### TECHNICAL FIELD

The field of the disclosure is recycling machines and recycling methods for recycling textile materials containing mixed yarn waste, in particular for recycling cotton fiber. The disclosure relates broadly to a device and method for recycling textile materials which contain natural fibers mixed with elastic synthetic mono-filament fibers, wherein the elastic mono-filament fibers shall be extracted to regain the natural fiber. The disclosure more specifically encompasses an extraction module and extraction method for extracting elastic synthetic mono fiber material from a fleece of mixed textile waste fiber material, furthermore a textile recycling machine or fine opening stage thereof comprising such an extraction module, a textile recycling method comprising such an extraction method, and a method for retrofitting a textile recycling machine with such an extraction module.

### BACKGROUND

WO2021/115931 A1, published on Jun. 17, 2021 in the name of Lenzing AG, discloses a process for recovering starting materials from mixed textile wastes containing blended fabrics. Treatment of the mixed textile waste containing cellulose and polyester components comprises steps of: aqueous treatment to depolymerize and dissolve the polyester component; separating the cellulose component from the treatment solution to recover a cellulose raw material; filtering the treatment solution; and precipitating and recovering a terephthalic acid-comprising polyester raw material using an adsorbing filter medium. However, cellulose material recovered by such chemical processing typically contains impurities that make it unsuitable for fiber spinning.

EP1234900 A1, published on Aug. 28, 2002 in the name of Maschinenfabrik Rieter AG, discloses a cleaning method and device to remove particulate impurities, such as plastic particles or other particles from raw cotton fiber material.

U.S. Pat. No. 3,308,944 A, published on Mar. 14, 1967 in the name of Reclamation Trades Res Organis, discloses a separation of mixtures of textile fibres by electrostatic means. The separation process comprises dispersing the fibres in a stream of air and electrostatically charging them. Wool fibres in the dispersion may acquire a positive charge and polyester fibers a negative charge, both of sufficient magnitude for separation purposes. In the air stream, different rates of decay of like charges on different fibres can also be used to separate the fibres.

CN107956081 A, published on 24 Apr. 2018 in the name of Ningbo High Tech Tone Shengwentu Textile Co. Ltd., discloses a textile apparatus for generating filaments, threads or the like. The textile apparatus comprises a fabric flattening line with a conveyor belt and flattening roller for flattening loose fabric material. The improvement is to replace the flattening roller by an electrostatic roller, which is part of a waste yarn suction, fusing and extraction mechanism. Static electricity is generated in the electrostatic roller by friction between an inner plastic roller and an outer rubber roller, such that polyester waste fibers are charged, adhere to the outer roller, are scraped-off therefrom by a scraper and are collected in a waste collection box. The polyester waste is sucked by air flow to a melt box, is molten and flows onto an extraction table having extraction holes, is sucked by an inclined piston plate through the extraction holes and slides under gravity into a lateral draw box. The up- and down-movement of the piston plate also provides an air flow through first and second air supply channels to the conveyor belt, which blows the loose fabric on the conveyor belt and causes the polyester waste yarn to stand up on the surface of the fabric, thus making it easier for the outer roller to adsorb the polyester waste yarn. This device incorporates a polyester fusing mechanism and is thus relatively complex. This device is specifically adapted to extract polyester waste yarn from loose fiber fabric.

CN109881306 A discloses a method for separating and recycling blended fabric. The method comprises steps of: (1) colour measurement; (2) fiberization treatment, in which the polyester and cotton blended fabrics are fibrillated by mechanical hooking, and the classified polyester and cotton blended fabrics are disassembled into uniformly dispersed polyester and cotton blended fibers; (3) chemical pretreatment to improve dispersibility and conductivity of polyester and cotton mixed fibers and increase the conductivity difference between polyester and cotton fibers; (4) dispersion, wherein the mixed fibers are dispersed into a uniform thin layer by mechanical vibration or airflow sedimentation; (5) electrostatic adsorption and separation, wherein the multi-component mixed fibers obtained after pretreatment and dispersion are put in an electric field, and the component fibers are subjected to upward flying rapid-and-slow separation or downward falling deviation far-and-near separation under the effect of electric field force; and (6) recycling and reuse treatment of the separated polyester and cotton fibers.

Generally, currently known methods rely on either chemical methods in aqueous solutions or electrostatic methods in the airflow to separate synthetic polyester fibers from natural cotton fibers in blended fabrics. Such blended fabrics contain synthetic fibers, such as polyester, in a typical range of e.g. several 10%, or e.g. in a range of 15% to 85% or a sub-range thereof.

### SUMMARY

The object of the disclosure is to provide a device and method for improved and simplified cleaning of fiber fleece containing mixed yarn waste from synthetic fiber material. This object is achieved by the subject-matter set forth in the independent claims. Some embodiments are given in the dependent claims and claim combinations and provide further improvements.

Throughout this application, natural fiber material is or contains cellulose fiber material, such as e.g. cotton fiber, hemp fiber, linen fiber, ramie fiber, sisal fiber, bamboo fiber, or mixtures thereof. Cellulose fibers have important advantages such as low density, low cost, they are recyclable and are biodegradable.

Textiles typically contain mixtures of natural and synthetic fibers. For example, textiles can contain or be made of core yarn having a synthetic continuous filament forming the stretchable core and natural fiber roving providing volume to the core. This is in contrast to blended fabrics, which contain large amounts of both synthetic fiber material(s) and natural fiber material(s).

Examples of synthetic fiber materials are polyester fiber, polyurethane fiber, Elastan fiber, polyamid fiber, viscose or rayon fiber, acrylic fiber, nylon fiber. In recycling such textile materials, mixed yarn waste containing natural and synthetic fiber material is obtained. There is a need to extract the synthetic fiber material in order to regain the natural fiber.

Core-yarn textile waste material comprises rather low amounts of synthetic fiber material, e.g. in a range of 1% to 15%, preferred 1% to 10%, more preferred 2% to 5% (e.g. in jeans). However, core-yarn textile waste material can also comprise up to 20% or up to 30% of synthetic fiber material, e.g. in bathing suits or the like.

A preferred synthetic fiber material for core-yarn textiles is elastan, which provides stretchability, in combination with cotton or viscose, which provides durability to the textile material. In recycling such core-yarn textile waste materials, rather small amounts of synthetic fiber must be extracted with high efficiency in order to obtain high degrees of purity of the separated natural and synthetic fiber materials.

Throughout this application, the term fiber fleece or briefly fleece describes an assembly of textile fibers sticking together in a non-woven manner. Such fleece can form a coherent strand of fiber material that can be transported by a conveyor belt, drive rollers or other mechanical transportation means. Such fleece is different from a flow of fiber, which can be transported pneumatically by air-flow.

The disclosure relates to an extraction module for extracting synthetic fiber material from mixed textile waste fiber material, in particular comprising or being core-yarn waste fiber material, containing synthetic fiber material and natural fiber material, in particular extraction module for implementing the method for extracting as disclosed herein, the extraction module comprising:
a. an electrostatic charging unit that is configured to be mountable at a textile recycling machine for electric charging a fiber fleece of the mixed textile fiber material and/or for moving charged synthetic fiber material closer to a surface of the fleece, and
b. a separation stage comprising separation means for removing a layer, in particular a surface layer, of the fiber fleece containing an increased or decreased concentration of the synthetic fiber material.

The extraction module has the advantage that natural fiber material can be regained with improved quality from a fleece of mixed yarn waste. This is achieved by using a two-step process implemented in the electrostatic charging unit or sub-module and the separation stage or preferably separation unit or sub-module. The extraction module allows to extract synthetic fiber material from the fleece of mixed yarn waste material with high efficiency and at relatively low cost. Preferably, the extraction module is configured to be mounted to textile recycling machines, in particular as a retrofit module.

In embodiments, the electrostatic charging unit or sub-module is configured to be mounted, in particular retrofitted, at a fine opening stage of the textile recycling machine. In particular, the electrostatic charging unit can be mounted or retrofitted after a carding stage of the textile recycling machine.

In embodiments, the extraction module can comprise an electrical interface for providing electric power to the electrostatic charging unit. Alternatively or in addition, the electrostatic charging unit may comprise means for friction-induced electrostatic charging of the fiber fleece, such as an electrostatic roller providing a triboelectric effect between two components of different material, such as a first plastic roller and second roller of different material or a plastic roller and the fleece itself. In additional embodiments, the extraction module can comprise mounting means configured for mounting or retrofitting the electrostatic charging unit to the textile recycling machine.

In embodiments, the electrical separation means comprise electrical separation means for applying an electric separation field to the charged fiber fleece for moving or further moving the charged synthetic fiber material closer to the surface of the fleece. In particular, the electrical separation means can comprise electrodes for applying the electric separation field to the charged fiber fleece and/or can comprise an electric roller or an electrostatic conveyor belt for electric charging the synthetic fiber material and/or electrically attracting the charged synthetic fiber material.

In embodiments, the separation means comprises mechanical fiber-treatment means for treating the charged fiber fleece in order to further move the charged synthetic fiber material closer to the surface of the fleece, in particular when exposed to the electric separation field. In particular, the mechanical fiber-treatment means can comprise a carding roller for carding the charged fiber fleece.

In embodiments, the separation means comprise mechanical separation means that are configured to remove a surface layer containing an increased concentration of the synthetic fiber material. Alternatively or in addition, the separation means comprise mechanical separation means that are configured to remove a layer, in particular opposite surface layer or volume layer, of the natural fiber material containing a decreased concentration of the synthetic fiber material. In particular, the mechanical separation means can comprise at least one separation tool selected from the group consisting of: tee roller, knife, skiving tool, knock-off toll, brush, brush roller, grate, or combinations thereof.

In embodiments, the separation stage is a separation unit or sub-module that is configured to be mounted to the textile recycling machine, in particular as a retrofit. In particular, the separation unit can comprise an electric interface for providing power for driving the separation means, and/or further comprises mounting means configured for mounting or retrofitting the mechanical separation unit to the textile recycling machine.

In alternative or additional embodiments, the separation stage is or comprises modified parts of the recycling machine, in particular of a fine opening stage or carding stage of the textile recycling machine. In particular, the modified parts of the textile recycling machine can comprise one or more of: a roller retrofitted with electric or triboelectric means to obtain an electrically chargeable roller, electric roller retrofit-mounted in proximity to a fiber fleece path in the recycling machine, electric separation-field generating means, e.g. comprising or being stationary electrodes or an electrostatic conveyor belt, retrofit-mounted in proximity to a fiber fleece path in the recycling machine, and combinations thereof.

In embodiments, the electric separation-field generating means comprise an electrostatic conveyor belt, which is movable by a drive and comprises an electrically charged pick-up region for attracting the charged synthetic fiber material and a release region for discarding the synthetic fiber material, in particular by a brush or suction cleaner.

In embodiments, the electrostatic conveyor belt is arranged above the mechanical fiber-treatment means and/or above the mechanical separation means.

In embodiments, the mechanical fiber-treatment means comprises a carding roller rotating in a transportation direction of the fiber fleece for carding and moving the fiber fleece into the electrostatic separation field of the electric separation means, in particular of the electrostatic conveyor belt. This has the advantage that the fiber fleece is more loosened and becomes subject to the electrostatic separation field such that the charged synthetic fiber material can move to the surface layer of the fleece which is adjacent to the electric separation means, in particular electrostatic conveyor belt.

In embodiments, the mechanical separation means comprise a counter-rotating roller, in particular brush roller, for separating a first layer, in particular volume layer, of the fiber fleece containing the natural fiber material with a decreased concentration of the synthetic fiber material from a second layer, in particular surface layer or upper surface layer, containing an increased concentration of the synthetic fiber material, in particular when the second layer is adhering to the electric separation means and preferably to the electrostatic conveyor belt.

In other words, the mechanical separation means, in particular brush roller, can cooperate with the electric separation means, in particular electrostatic conveyor belt, such that the first layer is deviated away from the electric separation means, in particular electrostatic conveyor belt, e.g. by being moved downwards, and the second layer is adheringly attached to the electrostatic conveyor belt and is thereby removed from the fiber fleece.

In another aspect, the disclosure relates to a textile recycling machine for treating a fleece of waste yarn containing synthetic fiber material and natural fiber material, in particular in a fine opening stage or carding stage of a textile recycling machine, in particular textile recycling machine for implementing the method for recycling textiles as disclosed herein, wherein the textile recycling machine comprises or is retrofitted with an extraction module as disclosed herein. In particular, the textile recycling machine comprises or is retrofitted with two or more extraction modules as disclosed herein. Preferably, the fleece of waste yarn is cleaned from the synthetic fiber material to obtain recycled natural fiber of a quality sufficient for reuse in fiber spinning or other processes, such as weaving, dyeing and finishing, in particular for reuse in fiber rotor spinning.

In embodiments of the textile recycling machine, the electric separation-field generating means, in particular the electrostatic conveyor belt, can be mounted on top of a carding device of the textile recycling machine and/or can replace a cover of the carding device. In further embodiments, the carding device of the textile recycling machine can comprise the mechanical fiber-treatment means and the mechanical separation means.

In embodiments, the textile recycling machine can comprise fleece transportation means for delivering the fleece to and from the extraction module, in particular a feeding conveyor belt, an exit conveyor belt, and optionally a rearward conveyor belt for refeeding the fleece to at least one of the extraction modules.

In embodiments, the textile recycling machine can comprise a suction roller, which is arranged after the separation stage of the extraction module and serves for recondensing the fiber fleece containing the natural fiber material obtained from the extraction module with improved purity.

In embodiments of the textile recycling machine, the extraction module does not comprise pneumatic means for transporting the fleece of the mixed textile waste fiber material, and/or the extraction module does not comprise chemical means for extracting fiber material components.

In another aspect, the disclosure relates to a method for extracting synthetic fiber material from a fleece of mixed textile waste fiber material containing a synthetic fiber material and a natural fiber material, in particular a method implemented in an extraction module as disclosed herein or in a textile recycling machine as disclosed herein, the method comprising the method steps of:
a. exposing the fleece to an electrostatic charging field provided by an electrostatic unit for electrostatic charging the synthetic fiber material in the fleece,
b. applying an electrostatic separation field provided by electric field-generating means for providing a movement direction of the charged synthetic fiber material towards a surface layer of the fleece,
c. mechanically treating the fleece by mechanical fiber-treatment means for promoting movement of the charged synthetic fiber material towards the surface layer of the fleece, in particular when the fleece is exposed to the electrostatic separation field, and
d. removing a layer containing an increased or decreased concentration of the synthetic fiber material by separation means, in particular mechanical separation means.

In embodiments, the method comprises in step d.: removing the surface layer containing an increased concentration of the synthetic fiber material by electric separation means, and/or removing an opposite surface layer or a volume layer of the natural fiber material containing a decreased concentration of the synthetic fiber material by mechanical separation means.

In embodiments, the method may comprise at least one of the method steps of:
a0. carding the fiber fleece before step a.,
b0. carding the fiber fleece after step a. and before step b., and
c0. carding the fiber fleece after step b. and before step c.

In embodiments, the step d. may comprise at least one of tee rolling, kniving, skiving, knocking-off, brushing or grating the fiber fleece for removing the layer, in particular surface layer.

In embodiments of the methods or textile recycling machine or extraction module disclosed herein, the fleece of mixed textile waste fiber material contains the synthetic fiber material in an initial concentration range of at most 10%, preferred at most 5%, more preferred at most 3%, more preferred at most 2%; and/or the fleece of mixed textile waste fiber material comprises or is core-yarn textile waste fiber material; and/or the fleece does not contain blended-fabrics textile waste fiber material.

In embodiments of the methods or textile recycling machine or extraction module disclosed herein, the synthetic fiber material is or comprises polyurethane, in particular elastan; and/or the synthetic fiber material is not or does not comprise polyester.

In embodiments, the method comprises the additional method step of repeating at least one of: the combined steps a. and b. or the step c. or the step d. or a combination thereof, until the recycled natural fiber is obtained in a quality that is sufficient for reuse in a fiber spinning process or other processes, such as weaving, dyeing and finishing, in particular for reuse in a fiber rotor spinning process.

In another aspect, the disclosure relates to a method for recycling textiles containing mixed yarn waste, in particular textile waste fiber material containing or being made of core-yarn, wherein a fleece of mixed textile waste fiber material containing a synthetic fiber material and a natural fiber material is formed, including the method for extracting synthetic fiber material from the fleece as disclosed herein.

In another aspect, the disclosure relates to a method for retrofitting a textile recycling machine (1) with an extraction module (2) according to any one of the claims 1 to 14, comprising the method steps of:
a. providing at least one extraction module, each extraction module comprising an electrostatic charging unit and a separation stage, in particular separation unit,
b. mounting the electrostatic charging unit to the textile recycling machine (1) and providing electric power to the electrostatic charging unit, and
c. mounting the separation stage to the textile recycling machine and providing electric power to the separation stage.

In embodiments, the electrostatic charging unit is retrofitted to a fine opening stage of the recycling machine; and/or the separation stage is retrofitted to a fine opening stage of the textile recycling machine.

It is to be understood that both the foregoing general description and the following detailed description present embodiments with optional features, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain in examples the principles and operation of the concepts disclosed herein.

### BRIEF DESCRIPTION OF THE DRAWINGS

The disclosure herein described will be more fully understood from the detailed description given herein below and the accompanying drawings which show or relate to exemplary embodiments only and shall not be construed to be limiting to the invention claimed in the appended claims. The drawings show schematically in:

FIG. 1 a schematic partial side view of a textile recycling machine for mixed yarn waste comprising an extraction module according to embodiments of the disclosure;

FIG. 2 a first flow diagram of the method for extracting synthetic fiber material, in particular in a general textile recycling process;

FIG. 3 a second flow diagram of the method for extracting synthetic fiber material, in particular in a general textile recycling process;

FIG. 4 a schematic partial side view of an extraction module according to embodiments of the disclosure;

FIG. 5 a schematic partial side view of an extraction module according to embodiments of the disclosure.

### DETAILED DESCRIPTION

Reference will now be made in detail to certain embodiments, examples of which are illustrated in the accompanying drawings, in which some, but not all features are shown. Embodiments disclosed herein may be embodied in many different forms, may include variations in one or more features or aspects, and may in general be combined with one another. Embodiments should not be construed as being limiting; rather, these embodiments are provided to assure that this disclosure will satisfy applicable legal requirements. In general, same reference numbers shall refer to same or similar components or parts.

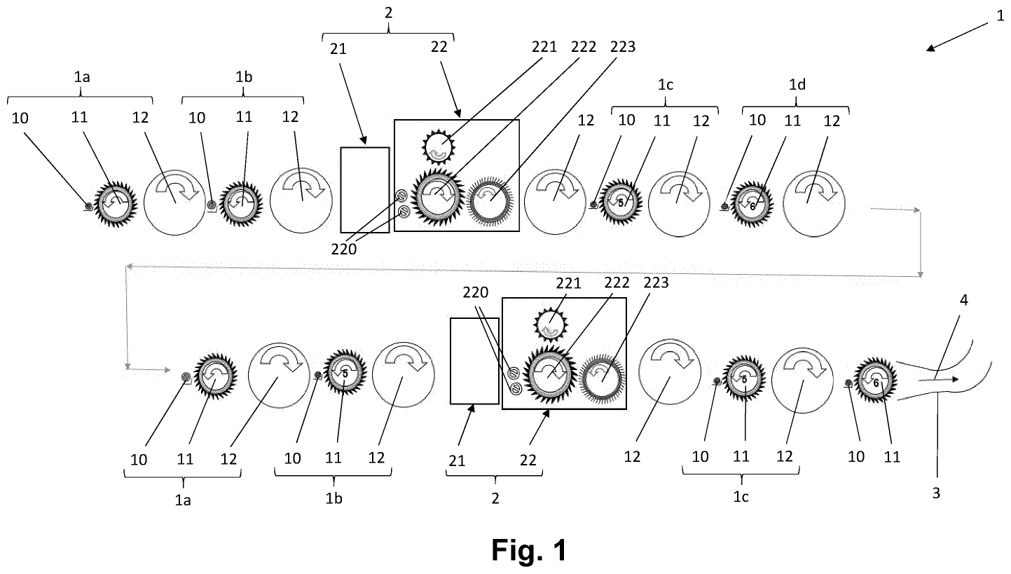

FIG. 1 shows a schematic and partial side view of a textile recycling machine 1 comprising fine opening stages 1a, 1b, 1c, 1d, in particular first and second carding stages 1a, 1b and third and fourth carding stages 1c, 1d. Therein, transport rollers 10 or entrance or feeding rollers 10 are present for controlled feeding the fiber fleece to the respective subsequent stage 1a, 1b, 1c, 1d. Such transport rollers 10 may be provided inside with underpressure to attract the fiber fleece (not shown) and to transport it to the next station. Furthermore, carding rollers 11 or rollers 11 with specific rollers sets, such as needle rollers, toothed rollers, wire rollers, combing rollers, or transport rollers in general, can be present. Also screen rollers 12 or screening drums 12 or cleaning rollers 12 may be present, which provide a sieve surface with underpressure inside such that dirt or waste can fall into the inside volume and can thus be extracted from the fiber fleece.

According to the disclosure an extraction module 2 is present. It comprises an electrostatic charging unit 21, which can be configured as a separate sub-module 21 for being retrofitted to the textile recycling machine 1. The electrostatic charging module 21 shall contain electric fiber-charging means (not shown in detail), such as electric or triboelectric rollers or static electrodes. Furthermore, the extraction module 2 comprises a separation stage 22, which can also be configured as a separate sub-module 22 for being retrofitted to the textile recycling machine 1. The separation stage 22 can comprise entrance rollers 220 for receiving the fiber fleece and delivering it in a controlled manner to the separation stage 22. The separation stage 22 can further comprise electric separation means 221 including electric separation-field generating means, e.g., electric or triboelectric roller(s); further can comprise mechanical fiber-treatment means 222, such as, e.g., carding roller(s), tambour roller(s), transport roller(s); and further can comprise mechanical separation means 223, such as, e.g., at least one of: tee roller, knife, skiving tool, knock-off toll, brush, brush roller, grate, or combinations thereof.

After the fiber fleece is cleaned from electrostatically and mechanically extracted synthetic fiber material, the cleaned fiber fleece is guided to the outlet channel 3 and is delivered therefrom as a fleece or flow 4 of mostly natural fiber, preferably as a cotton fiber flow which is of high purity suitable for further processing in spinning or other processes, such as weaving, dyeing and finishing, in particular rotor spinning.

Furthermore, the recycling machine 1 can comprises fine opening or carding stages 1c, 1d equipped with rollers having different types of roller sets or metal pins, as indicated by reference numerals 5 and 6. Herein, carding is a mechanical process that disentangles, cleans and intermixes fibers to produce a continuous web or sliver suitable for subsequent processing. This is achieved by passing the fibers between differentially moving surfaces covered with card clothing. It breaks up locks and unorganized clumps of fiber and then aligns the individual fibers to be parallel with each other.

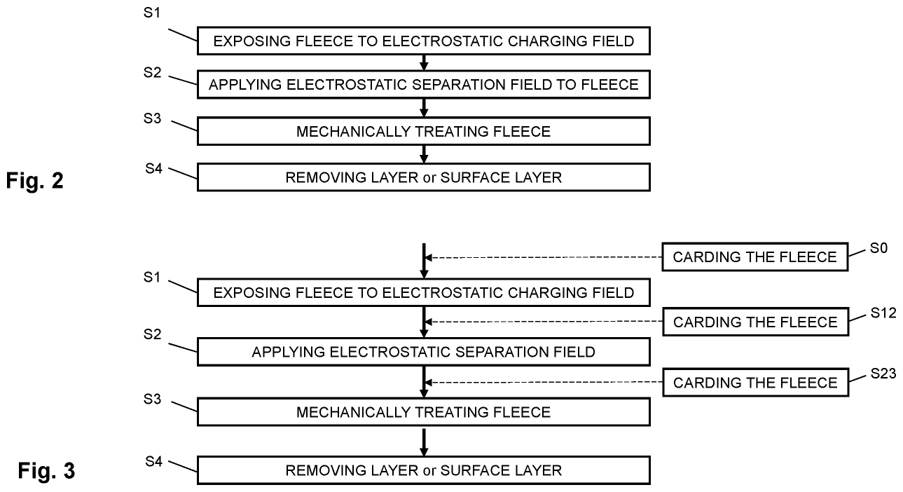

FIG. 2 shows a flow diagram illustrating the method for extracting of the method for extracting synthetic fiber material, in particular in a general textile recycling process. In step S1, the fiber fleece is charged by an electrostatic charging field. In step S2, an electrostatic separation field is applied to the fiber fleece to provide a movement of the charged synthetic fiber material towards a surface layer of the fiber fleece. In step S3, the fiber fleece is mechanically treated to promote the movement of the charged synthetic fiber material towards the surface layer of the fiber fleece. And in step S4, a layer containing an increase or decreased concentration of the synthetic fiber material, in particular a surface layer containing an increased concentration of the synthetic fiber material, is removed by the mechanical separation means 223.

FIG. 3 shows an enhanced flow diagram, in which intermitted carding stages are alternatively or in sub-combinations or all together applied in steps S0, S12, and/or S23.

In summary, the extraction module 2 is able to reclaim natural fiber from mixed waste fiber fleece in a quality sufficient for reuse in spinning, in particular rotor spinning, or weaving and similar processes by providing a two-step process with electrostatic and mechanical means for extracting the synthetic fiber material. In particular, the separation stage 22 can include rollers, turners and/or tambours and an electric separation field for further moving the charged synthetic fiber material closer to the surface of the fleece. Finally, removal of the synthetic fiber material is achieved mechanically by removing a surface layer of the fleece which contains an enriched concentration of the synthetic fiber material, or by removing a layer of the fleece which contains the natural fiber material with a reduced concentration of the synthetic fiber material.

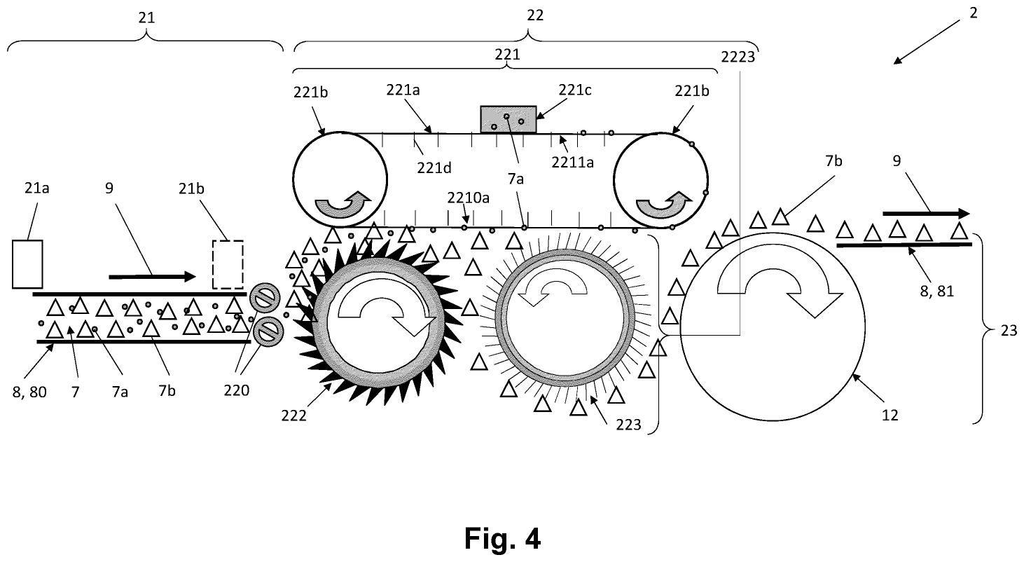

FIG. 4 shows in more detail an embodiment of an extraction module 2 comprising: a feeding conveyor belt 8, 80 for delivering fiber fleece 7 containing synthetic fiber material 7a and natural fiber material 7b; an electrostatic charging unit 21, which may comprise a first electric means 21a and/or second electric means 21b, for charging the fiber fleece 7 and in particular the synthetic fiber material 7a, and/or for moving charged synthetic fiber material 7a closer to a surface of the fiber fleece 7; a separation unit 22 comprising separation means 221, 222, 223, in particular an electric separation means 221, a mechanical fiber-treatment means 222 and a mechanical separation means 223; and an output stage 23 comprising exit transporting means such as a roller 12 and exit conveyor belt 81.

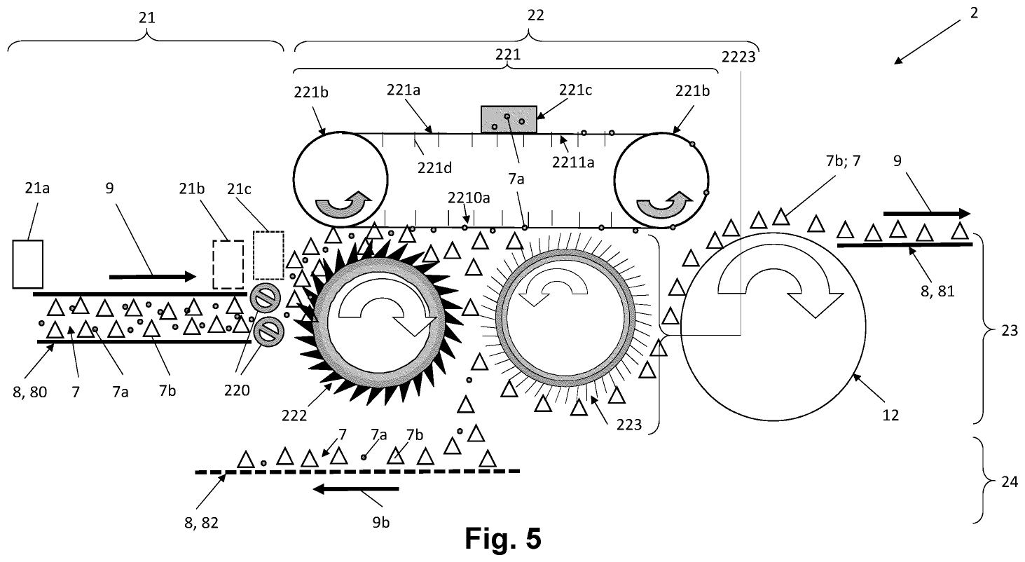

As shown in FIGS. 4 and 5, the electrostatic charging unit 21 can comprise at least one of the electric means 21a, 21b and 21c, such that charging of the synthetic fiber material 7a can be achieved; and optionally in addition moving charged synthetic fiber material 7a closer to a surface of the fiber fleece 7 can be achieved, in particular in cooperation with the fiber-treatment means 222.

As shown in FIG. 4, the mechanical fiber-treatment means 222 can comprise a carding roller 222 rotating in a transportation direction 9 of the fiber fleece 7 for carding and moving the fiber fleece 7 into the electrostatic separation field (not shown) of the electric separation means 221, in particular electrostatic conveyor belt 221a for example comprising carrier elements 221d. Herein, the transportation direction 9 can denote a forward or main transportation direction 9 of the fiber fleece material 7 through the extraction module 2 of the recycling machine 1.

The electrostatic conveyor belt 221a can be movable in the transportation direction 9 by a drive 221b, e.g. drive rollers 221b, and can comprise an electrically charged pick-up region 2210a for attracting the charged synthetic fiber material 7a and a release region 2211a for discarding the synthetic fiber material 7a, in particular by a brush cleaner 221c or suction cleaner 221c.

The mechanical separation means 223 can comprise a counter-rotating roller 223, in particular brush roller 223, for deviating the fleece 7 away from the electric separation means 221, in particular electrostatic conveyor belt 223, e.g. by a downward movement. Herein, the mechanical separation means 223, in particular brush roller 223, is arranged underneath and in proximity to the electric separation means 221, in particular electrostatic conveyor belt 221. This allows to separate a first layer, in particular volume layer, of the fiber fleece 7 containing the natural fiber material 7b with a decreased concentration of the synthetic fiber material 7a from a second layer, in particular surface layer, containing an increased concentration of the synthetic fiber material 7a, which adheres at least partially to the electric separation means 221, preferably electrostatic conveyor belt 221a.

When retrofitting a textile recycling machine 1 with a synthetic fiber extraction module 2 as disclosed herein, the electric separation means 221, in particular electrostatic conveyor belt 221, can be placed on top of a carding device 2223 which comprises the mechanical fiber-treatment means 222 and the mechanical separation means 223. For example, the electrostatic conveyor belt 221 can replace a cover or hood of the carding device 2223.

In the output stage 23, the roller 12 can be a suction roller 12 or screening drum 12, which is arranged after the separation stage 22 of the extraction module 2 and serves for recondensing the fiber fleece 7 containing the natural fiber material 7b obtained from the extraction module 2 with improved purity. The roller 12 can rotate in the transportation direction 9 and can transport the fiber fleece 7 towards the exit conveyor belt 81.

In embodiments, depending on the purity level of the natural fiber material 7b, i.e. the rest concentration of synthetic fiber material 7a contained therein, the exit conveyor belt 81 can for example transport the fiber fleece 7 to another extraction module 2. Alternatively, the exit conveyor belt 81 can transport the purified natural fiber material 7a to an outlet channel 3 (as shown in FIG. 1), or even the exit conveyor belt 81 can be replaced by an outlet channel 3 (not shown in FIG. 4).

Alternatively or in addition to these embodiments shown in FIG. 4, the extraction module 2 can comprise a recycling stage 24 (FIG. 5) for refeeding not yet sufficiently purified fiber fleece material 7 containing besides the natural fiber material 7b substantial rest concentration of synthetic fiber material 7a. The recycling stage 24 can comprise rearward transportation means 82, e.g. a rearward conveyor belt 82, that is arranged underneath the separation stage or unit 22, in particular the mechanical separation means 223 and/or mechanical fiber-treatment means 222, for collecting insufficiently purified fiber fleece material 7 and transporting it in backward transportation direction 9b for refeeding it to a preceding or the same extraction module 2.

### LIST OF DESIGNATIONS

1 textile recycling machine
1a, 1b fine opening stage, carding stage, first/second carding stage
1c, 1d fine opening stage, carding stage, third/fourth carding stage, etc.
10 transport roller, entrance roller, feeding roller
11 carding roller, roller with roller set; needle roller, toothed roller, wire roller, combing roller; transport roller
12 screen roller, screening drum, cleaning roller, vacuum suction roller (for purified natural fiber material)
2 extraction module
21 electrostatic charging unit, electrostatic charging sub-module, electric fiber-charging means
21a, 21b, 21c electric means
22 separation stage, separation unit, separation sub-module
221, 222, 223 separation means
220 entrance rollers, feeding rollers to extraction module
221 electric separation means, electric separation-field generating means, electric roller, electrostatic separation field
221a electrostatic conveyor belt, electrostatic cover of a carding device 2223
2210a electrically charged pick-up region for attracting charged synthetic fiber material
2211a release region for discarding charged synthetic fiber material
221b drive for electrostatic conveyor belt, drive rollers
221c cleaner, vacuum cleaner, suction cleaner, brush, synthetic fiber collector
221d carrier elements of electrostatic conveyor belt
222 mechanical fiber-treatment means, carding roller, tambour roller, transport roller
223 mechanical separation means, tee roller, knife, skiving tool, knock-off toll, brush, brush roller, grate
2223 carding device comprising the mechanical fiber-treatment means and the mechanical separation means
23 transportation stage, output stage
24 recycling stage, refeeding stage
3 outlet channel
4 cleaned fiber flow, cotton fiber flow
5 first roller with first type of roller set or metal pins, first mechanical fiber-treatment roller, first toothed roller
6 second roller with second type of roller set or metal pins, second mechanical fiber-treatment roller, second toothed roller
7 fleece of mixed textile waste fiber material, fleece of core-yarn textile waste fiber material
7a synthetic fiber material
7b natural fiber material
8 fleece transportation means, conveyor means, conveyor belt
80 feeding conveyor belt, feeding conveyor means
81 exit conveyor belt, exit conveyor means
82 rearward conveyor belt/means, refeeding conveyor belt/means
9 transport direction, forward transportation direction
9b transportation direction, backward transportation direction

1. An extraction Module for extracting synthetic fiber material from mixed textile waste fiber material, in particular comprising or being core-yarn waste fiber material, containing synthetic fiber material and natural fiber material, the extraction module comprising:
a. an electrostatic charging unit that is configured to be mountable at a textile recycling machine for electric charging a fiber fleece of the mixed textile fiber material and/or for moving charged synthetic fiber material closer to a surface of the fiber fleece, and
b. a separation stage comprising separation means for removing a layer, in particular a surface layer, of the fiber fleece containing an increased or decreased concentration of the synthetic fiber material.

2. The extraction module of claim 1, wherein the electrostatic charging unit is configured to be mounted, in particular retrofitted, at a fine opening stage of the textile recycling machine.

3. The extraction module of claim 1, wherein the electrostatic charging unit is configured to be mounted, in particular retrofitted, after a carding stage of the textile recycling machine.

4. The extraction module of claim 1, further comprises an electrical interface for providing electric power to the electrostatic charging unit, and/or further comprises mounting means configured for mounting or retrofitting the electrostatic charging unit to the textile recycling machine.

5. The extraction module of claim 1, wherein the separation means comprise electrical separation means for applying an electric separation field to the charged fiber fleece for moving or further moving the charged synthetic fiber material closer to the surface of the fiber fleece.

6. The extraction module of claim 5, wherein the electrical separation means comprise electrodes for applying the electric separation field to the charged fiber fleece and/or comprise an electric roller or an electrostatic conveyor belt for electric charging the synthetic fiber material and/or electrically attracting the charged synthetic fiber material.

7. The extraction module of claim 1, wherein the separation means comprise mechanical fiber-treatment means for treating the charged fiber fleece in order to further move the charged synthetic fiber material closer to the surface of the fleece, in particular when exposed to the electrostatic separation field.

8. The extraction module of claim 7, wherein the mechanical fiber-treatment means comprise a carding roller for carding the charged fiber fleece.

9. The extraction module of claim 1, wherein the separation means comprise mechanical separation means that are configured to remove a surface layer containing an increased concentration of the synthetic fiber material.

10. The extraction module of claim 1, wherein the separation means comprise mechanical separation means that are configured to remove a layer, in particular opposite surface layer or volume layer, of the natural fiber material containing a decreased concentration of the synthetic fiber material.

11. The extraction module of claim 9, wherein the mechanical separation means comprises at least one separation tool selected from the group consisting of: a tee roller, a knife, a skiving tool, a knock-off toll, a brush, a brush roller, a grate, or combinations thereof.

12. The extraction module of claim 1, wherein the separation stage is a separation unit that is configured to be mounted to the textile recycling machine, in particular as a retrofit.

13. The extraction module of claim 12, wherein the separation unit comprises an electric interface for providing power for driving the separation means, and/or further comprises mounting means configured for mounting or retrofitting the mechanical separation unit to the textile recycling machine.

14. The extraction module of claim 1, wherein the separation stage is or comprises modified parts of the recycling machine, in particular of a fine opening stage or carding stage of the textile recycling machine.

15. The extraction module of claim 14, wherein the modified parts of the textile recycling machine comprise one or more of: a roller retrofitted with electric or triboelectric means to obtain an electrically chargeable roller; an electric roller retrofit-mounted in proximity to a fiber fleece path in the recycling machine; an electric separation-field generating means, e.g. comprising or being stationary electrodes or an electrostatic conveyor belt, retrofit-mounted in proximity to a fiber fleece path in the recycling machine; and combinations thereof.

16. The extraction module of claim 15, wherein the electric separation-field generating means comprise an electrostatic conveyor belt, which is movable by a drive and comprises an electrically charged pick-up region for attracting the charged synthetic fiber material and a release region for discarding the synthetic fiber material, in particular by a brush cleaner or suction cleaner.

17. The extraction module of claim 15, wherein the electrostatic conveyor belt is arranged above the mechanical fiber-treatment means and/or above the mechanical separation means.

18. The extraction module of claim 5, wherein the mechanical fiber-treatment means comprises a carding roller rotating in a transportation direction of the fiber fleece for carding and moving the fiber fleece into the electrostatic separation field of the electric separation means, in particular of an electrostatic conveyor belt.

19. The extraction module of claim 5, wherein the mechanical separation means comprise a counter-rotating roller, in particular a brush roller, for separating a first layer, in particular a volume layer, of the fiber fleece containing the natural fiber material with a decreased concentration of the synthetic fiber material from a second layer, in particular a surface layer, containing an increased concentration of the synthetic fiber material, in particular when adhering to the electric separation means, preferably an electrostatic conveyor belt.

20. A textile recycling machine for treating a fleece of waste yarn containing synthetic fiber material and natural fiber material, in particular a fine opening stage or carding stage of a textile recycling machine, in particular the textile recycling machine for implementing the method for recycling textiles according to claim 35, wherein the textile recycling machine comprises or is retrofitted with an extraction module for extracting synthetic fiber material from mixed textile waste fiber material, in particular comprising or being core-yarn waste fiber material, containing synthetic fiber material and natural fiber material, the extraction module comprising: a) an electrostatic charging unit that is configured to be mountable at a textile recycling machine for electric charging a fiber fleece of the mixed textile fiber material and/or for moving charged synthetic fiber material closer to a surface of the fiber fleece, and b) a separation stage comprising separation means for removing a layer, in particular a surface layer, of the fiber fleece containing an increased or decreased concentration of the synthetic fiber material.

21. The textile recycling machine of claim 20, which comprises or is retrofitted with two or more extraction modules according to claim 1.

22. The textile recycling machine of claim 20, wherein the electric separation-field generating means, in particular the electrostatic conveyor belt, is mounted on top of a carding device of the textile recycling machine and/or replaces a cover of the carding device.

23. The textile recycling machine of claim 20, wherein the carding device of the textile recycling machine comprises the mechanical fiber-treatment means and the mechanical separation means.

24. The textile recycling machine of claim 20, comprising fleece transportation means for delivering the fleece to and from the extraction module, in particular a feeding conveyor belt, an exit conveyor belt, and optionally a rearward conveyor belt for refeeding the fleece to at least one of the extraction modules.

25. The textile recycling machine of claim 20, comprising a suction roller, which is arranged after the separation stage of the extraction module and serves for recondensing the fiber fleece containing the natural fiber material obtained from the extraction module with improved purity.

26. The textile recycling machine of claim 20, wherein the extraction module does not comprise pneumatic means for transporting the fleece of the mixed textile waste fiber material, and/or wherein the extraction module does not comprise chemical means for extracting fiber material components.

27. The textile recycling machine of claim 20, wherein the fleece of waste yarn is cleaned from the synthetic fiber material to obtain recycled natural fiber of a quality sufficient for reuse in fiber spinning, in particular fiber rotor spinning.

28. A method for extracting synthetic fiber material from a fleece of mixed textile waste fiber material containing a synthetic fiber material and a natural fiber material, in particular the method being implemented by an extraction module of claim 1, the method comprising the method steps of:
a. exposing the fleece to an electrostatic charging field provided by an electrostatic unit for electrostatic charging the synthetic fiber material in the fleece,
b. applying an electrostatic separation field provided by electric field-generating means for providing a movement direction of the charged synthetic fiber material towards a surface layer of the fleece,
c. mechanically treating the fleece by mechanical fiber-treatment means for promoting movement of the charged synthetic fiber material towards the surface layer of the fleece, in particular when the fleece is exposed to the electrostatic separation field, and
d. removing a layer containing an increased or decreased concentration of the synthetic fiber material by separation means, in particular mechanical separation means.

29. The method of claim 28, comprising in step d.: removing the surface layer containing an increased concentration of the synthetic fiber material by electric separation means, and/or removing an opposite surface layer or a volume layer of the natural fiber material containing a decreased concentration of the synthetic fiber material by mechanical separation means.

30. The method of claim 28, comprising at least one of the method steps of:
a0. carding the fiber fleece before step a.,
b0. carding the fiber fleece after step a. and before step b., and
c0. carding the fiber fleece after step b. and before step c.

31. The method of claim 28, wherein the step d. comprises at least one of: tee rolling, kniving, skiving, knocking-off, brushing or grating the fiber fleece for removing the layer, in particular a surface layer.

32. The method of claim 28, wherein the fleece of mixed textile waste fiber material contains the synthetic fiber material in an initial concentration range of at most 10%, preferred at most 5%, more preferred at most 3%, more preferred at most 2%; and/or wherein the fleece of mixed textile waste fiber material comprises or is core-yarn textile waste fiber material; and/or wherein the fleece does not contain blended-fabrics textile waste fiber material.

33. The method of claim 28, wherein the synthetic fiber material is or comprises polyurethane, in particular elastan; and/or wherein the synthetic fiber material is not or does not comprise polyester.

34. The method of claim 28, comprising the additional method step of repeating at least one of: the combined steps a. and b. or the step c. or the step d. or a combination thereof, until the recycled natural fiber is obtained in a quality that is sufficient for reuse in a fiber spinning process, in particular fiber rotor spinning process.

35. Method for recycling textiles containing mixed yarn waste, wherein a fleece of mixed textile waste fiber material, in particular comprising or being core-yarn waste, containing a synthetic fiber material and a natural fiber material is formed, wherein the method for extracting synthetic fiber material from the fleece is performed according to claim 28.

36. Method for retrofitting a textile recycling machine with an extraction module according to claim 1, comprising the method steps of:
a. providing at least one extraction module, each extraction module comprising an electrostatic charging unit and a separation stage, in particular separation unit,
b. mounting the electrostatic charging unit to the textile recycling machine and providing electric power to the electrostatic charging unit, and
c. mounting the separation stage to the textile recycling machine and providing electric power to the separation stage.

37. The method of claim 36, wherein the electrostatic charging unit is retrofitted to a fine opening stage of the recycling machine; and/or wherein the separation stage is retrofitted to a fine opening stage of the textile recycling machine.
